(19) United States
(12) Patent Application Publication
(10) Pub. No.: US 2025/0284996 A1
(43) Pub. Date: Sep. 11, 2025

(54) DIGITAL QUANTUM ALGORITHM FOR MOLECULAR VIBRONIC SPECTRA

(71) Applicant: International Business Machines Corporation, Armonk, NY (US)

(72) Inventors: Niall Robertson, Dublin (IE); Sumit Suresh Kale, West Lafayette, IN (US); Omar Shehab, Yorktown Heights, NY (US)

(21) Appl. No.: 18/597,248

(22) Filed: Mar. 6, 2024

(51) Int. Cl. G06N 10/60; G06N 10/20; G06N 10/40

(52) U.S. Cl. CPC G06N 10/60; G06N 10/20; G06N 10/40

(57) ABSTRACT

A system comprises a memory that stores computer executable components, and a processor that executes the computer executable components stored in the memory, wherein the computer executable components comprise: an execution component that directs execution of a time dependent quantum algorithm at a quantum processor of a quantum system, wherein the quantum algorithm comprises propagating a wave packet in time under a determined Hamiltonian, resulting in a measurable output at the quantum system, and an evaluation component that determines an expectation value based on the output and corresponding to a vibrationally resolved electronic spectrum of a molecule.

### STATEMENT OF GOVERNMENT SUPPORT

This invention was made with government support under HR001122C0102 awarded by Defense Advanced Research Projects Agency (DARPA). The government has certain rights to this invention.

### BACKGROUND

The subject disclosure relates to quantum computing systems and more specifically to determination of a vibrationally resolved electronic spectrum using a quantum computing system.

### SUMMARY

The following presents a summary to provide a basic understanding of one or more embodiments described herein. This summary is not intended to identify key or critical elements, and/or to delineate scope of particular embodiments or scope of claims. Its sole purpose is to present concepts in a simplified form as a prelude to the more detailed description that is presented later. In one or more embodiments, systems, computer-implemented methods, apparatuses and/or computer program products described herein can provide for determining a vibrationally resolved electronic spectrum of a molecule.

In accordance with an embodiment, a system can comprise a memory that stores computer executable components; and a processor that executes the computer executable components stored in the memory, wherein the computer executable components comprise: an execution component that directs execution of a time dependent quantum algorithm at a quantum processor of a quantum system, wherein the quantum algorithm comprises propagating a wave packet in time under a determined Hamiltonian, resulting in a measurable output at the quantum system; and an evaluation component that determines an expectation value based on the output and corresponding to a vibrationally resolved electronic spectrum of a molecule.

In accordance with another embodiment, a computer-implemented method can comprise directing, by a system operatively coupled to a processor, execution of a time dependent quantum algorithm at a quantum processor of a quantum system, wherein the quantum algorithm comprises propagating a wave packet in time under a determined Hamiltonian, resulting in a measurable output at the quantum system; and determining, by the system, an expectation value based on the output and corresponding to a vibrationally resolved electronic spectrum of a molecule.

In accordance with still another embodiment, a computer program product, facilitating a process to determine a vibrationally resolved electronic spectrum of a molecule, can comprise a computer readable storage medium having program instructions embodied therewith, the program instructions executable by a processor to cause the processor to: direct, by the processor, execution of a time dependent quantum algorithm at a quantum processor of a quantum system, wherein the quantum algorithm comprises propagating a wave packet in time under a determined Hamiltonian, resulting in a measurable output at the quantum system; and determine, by the processor, an expectation value based on the output and corresponding to the vibrationally resolved electronic spectrum of the molecule.

A benefit of the system, computer-implemented method and/or computer program product can be an ability to, during quantum experiment setup, perform an easy initialization of an initial state of the qubits being employed in that the quantum circuit executed and/or directed to be executed by the system, computer-implemented method and/or computer program product employs a ground state of zero for each of the qubits being employed.

Another benefit of the system, computer-implemented method and/or computer program product can be an ability to employ a single ancilla qubit (also referred to as an ancillary qubit) and magnitudes fewer gates than conventional frameworks for determining a vibrationally resolved electronic spectrum of a molecule. That is, a number of cycles, a number of qubits employed, a quantum circuit qubit depth, a quantum circuit gate quantity, a quantum circuit gate complexity, a power employed and/or a time employed to determine such vibrationally resolved electronic spectrum can be reduced as compared to conventional frameworks.

Yet another benefit of the system, computer-implemented method and/or computer program product can be a reduction in errors cause and/or assumptions taken to determine the vibrationally resolved electronic spectrum of a molecule, such as in view of lack of use of quantum phase estimation and/or fault tolerancing. In connection therewith, the system, computer-implemented method and/or computer program product can employ a framework that is easily amenable to error mitigation, as compared to conventional frameworks employing quantum phase estimation (QPE) for which error mitigation at a level necessary for determination of vibrationally resolved electronic spectra is not presently possible.

Still another benefit of the system, computer-implemented method and/or computer program product can be an ability for use thereof with industries requiring rapid vibrationally resolved electronic spectrum determination for manufacture of large quantities of products, such as with respect to spectra of lithium ions relative to battery manufacturing.

### DESCRIPTION OF THE DRAWINGS

FIG. 1 illustrates a block diagram of an example, non-limiting system that can provide a process to determine a vibrationally resolved electronic spectrum, in accordance with one or more embodiments described herein.

FIG. 2 illustrates a block diagram of another example, non-limiting system that can provide a process to determine a vibrationally resolved electronic spectrum, in accordance with one or more embodiments described herein.

FIG. 3 illustrates a block diagram of a quantum system that can be employed in connection with the non-limiting systems of FIGS. 1 and 2, in accordance with one or more embodiments described herein.

FIG. 4 provides a diagrammatic illustration of a quantum circuit of a conventional framework to provide an example for contrasting with the diagrammatic illustration of FIG. 5.

FIG. 5 provides a diagrammatic illustration of a quantum circuit that can be generated by the non-limiting system of FIG. 2 and executed by the quantum system of FIG. 3, in accordance with one or more embodiments described herein.

FIG. 6 illustrates a flow diagram of one or more processes that can be performed by the non-limiting system of FIG. 2, to determine a vibrationally resolved electronic spectrum, in accordance with one or more embodiments described herein.

FIG. 7 illustrates a block diagram of a set of processes that can be performed by the non-limiting system of FIG. 2, in accordance with one or more embodiments described herein.

FIG. 8 illustrates a graph demonstrating one or more processes that can be performed by the non-limiting system of FIG. 2, in accordance with one or more embodiments described herein.

FIG. 9 illustrates a flow diagram of one or more processes that can be performed by the non-limiting system of FIG. 2, to determine a vibrationally resolved electronic spectrum, in accordance with one or more embodiments described herein.

FIG. 10 illustrates a continuation of the flow diagram of FIG. 11 of one or more processes that can be performed by the non-limiting system of FIG. 2, in accordance with one or more embodiments described herein.

FIG. 11 illustrates a block diagram of an example, non-limiting, computer environment in accordance with one or more embodiments described herein.

### DETAILED DESCRIPTION

The following detailed description is merely illustrative and is not intended to limit embodiments and/or application or utilization of embodiments. Furthermore, there is no intention to be bound by any expressed or implied information presented in the preceding Summary section, or in the Detailed Description section. One or more embodiments are now described with reference to the drawings, wherein like reference numerals are utilized to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

As a brief summary, in practice, calculating a molecule's absorption spectrum can aid interpretation of experimental spectrum and can guide cost-effective laboratory synthesis for compounds with certain optical characteristics. Given the rich complex vibrational structure of molecules, the classical computation of accurate vibrationally resolved electronic (e.g., vibronic) spectra scale combinatorially. Conventional quantum algorithms follow a fault-tolerant approach that necessitates extremely deep quantum circuits and multiple controlled trotterized gates. Differently, proposed herein is a resource-efficient near-term quantum framework that can drastically reduce the depth and breadth of a quantum circuit being employed for determining a vibrationally resolved electronic spectrum (VRES), also herein referred to as a vibronic spectrum.

Turning first to spectroscopy generally, spectroscopy can be a good method for analyzing light-matter interactions. For example, the technique can be employed to ascertain whether a specific molecule is present in a sample and/or to calculate a concentration of the specific molecule in the sample. Specificity of the technique can enable compounds in a sample to be identified from one another. Uses are many and can include chemical analysis (such as in lithium battery production), environmental monitoring, molecular physics, biosensing and/or bioimaging. For theoretical models of molecules, the computation of spectra can provide a benchmark. Indeed, an understanding of chemical phenomena can depend on a connection between theory and experiment.

Molecular spectra can be difficult to predict, particularly for large molecular systems, for molecules which show significant entanglement between degrees of freedom and in situations where exceptional accuracy of spectra resolution is desired. In one type of spectra, that of a vibronic spectrum (i.e., a vibrationally resolved electronic spectrum), a vibronic transition can be proportional to an overlap between initial and final vibrational wavefunctions. Calculations for the full vibronic spectrum can often suffer from an issue of dimensionality due to inclusion of an exponential number of relevant vibrational states. That is, calculation of vibronic spectra can scale exponentially. This impacts classical algorithms, restricting their application to smaller molecular systems only. When looking to quantum simulation, such as to lower a computational expense involved in predicting molecular spectra, a potential advantage can come from an intrinsic ability to naturally map and process high dimensional entangled wavefunctions. However, conventional approaches employing quantum simulation employ an exceedingly long preparation of an initial state, require an abundance of assumptions, such as to get around the dimensions of a respective Hilbert space, and/or result in a variety of known errors. Furthermore, various algorithm types, such as quantum phase estimation (QPE) simply cannot be implemented on current or even near-term quantum systems due to issues of control qubit quantity, quantum circuit depth and/or errors in measurement of a lengthy qubit bit string.

To account for one or more of these deficiencies, the one or more frameworks discovered by the inventors and discussed herein can be employed for determining a vibrationally resolved electronic spectrum of a molecule using a combination of classical computation and quantum computing to provide a framework that is both easier and more efficient than conventional frameworks related to vibronic spectra. Generally, the one or more frameworks discussed herein can provide for implementation of a time-independent formalism using a Hadamard-based (or Hadamard test-based) approach. Relative to conventional frameworks, such frameworks discussed herein can provide a 90% to 98% reduction in gate depth (e.g., quantum circuit depth) relative to a two-qubit example. Furthermore, the one or more frameworks discussed herein can be employed relative to large molecules without use of various Hilbert space assumptions/approximations, without incurrence of various assumption-based/approximation-based errors, and without costly quantum system initialization which all are associated with conventional approaches. The Hadamard-based approach discuss herein further uses significantly fewer resources (e.g., qubits) than conventional approaches.

As used herein, a harmonic approximation refers to an assumption that a potential energy of a vibrational Hamiltonian is a simple quadratic function.

As a result, a vibrationally resolved electronic spectrum can be generated having an industry-accepted accuracy of resolution, such as of 50 cm¹ resolution, without the use of a plurality of control qubits. Indeed, a single ancilla/control qubit can be employed relative to one or more data qubits, at a quantum system, to execute a classically-derived algorithm, with limited quantum system initialization. Indeed, due use of vibrational Hamiltonians, such forms can have a simple ground state where all states of the respective qubits can be set to zero. Thus, a natural state of a quantum system can be employed for initialization, drastically reducing time, effort and/or complexity of related quantum execution.

As such, the one or more embodiments herein can provide for automatic or at least partially automatic generation of, and direction of execution of, a set of quantum circuits for determining a VRES. Put another way, the one or more embodiments described herein can employ a combination of classical and quantum processes performed on physical qubits of a quantum processor to provide one or more quantum measurement readouts that can be employed, by the one or more embodiments, to determine one or more expectation values, which in turn can be employed, by the one or more embodiments, to generate the VRES by use of a Fourier transform-based analysis approach.

As used herein, the term “data” can comprise metadata.

As used herein, the terms “entity,” “requesting entity,” “user entity,” and “administrating entity” can refer to a machine, device, component, hardware, software, smart device, party, organization, individual and/or human.

One or more embodiments are now described with reference to the drawings, where like referenced numerals are used to refer to like elements throughout. In the following description, for purposes of explanation, numerous specific details are set forth to provide a more thorough understanding of the one or more embodiments. It is evident in various cases, however, that the one or more embodiments can be practiced without these specific details.

Further, it should be appreciated that the embodiments depicted in one or more figures described herein are for illustration only, and as such, the architecture of embodiments is not limited to the systems, devices and/or components depicted therein, nor to any particular order, connection and/or coupling of systems, devices and/or components depicted therein.

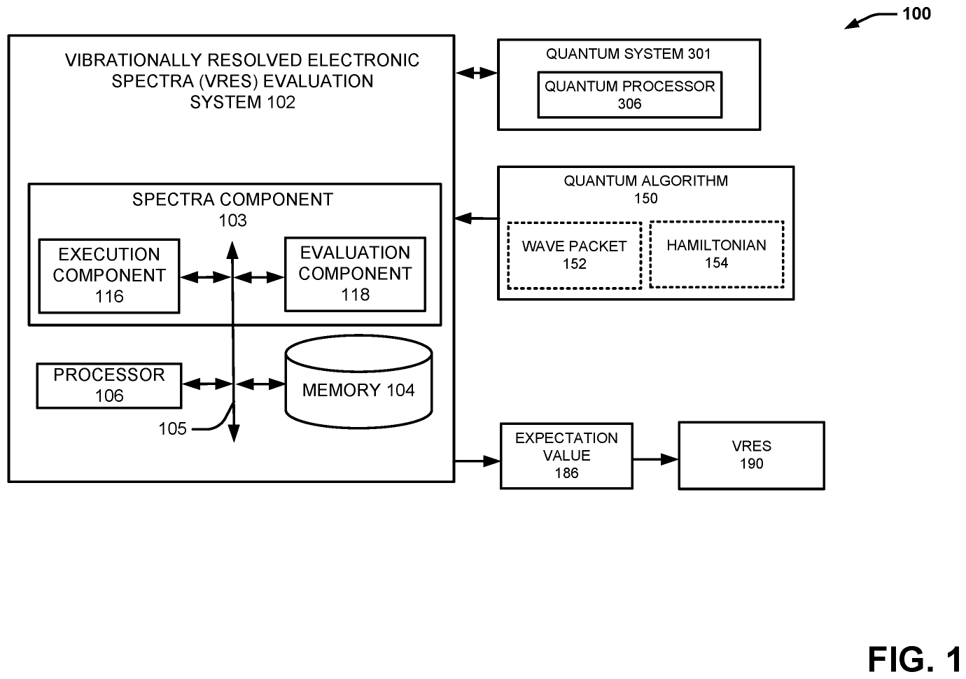

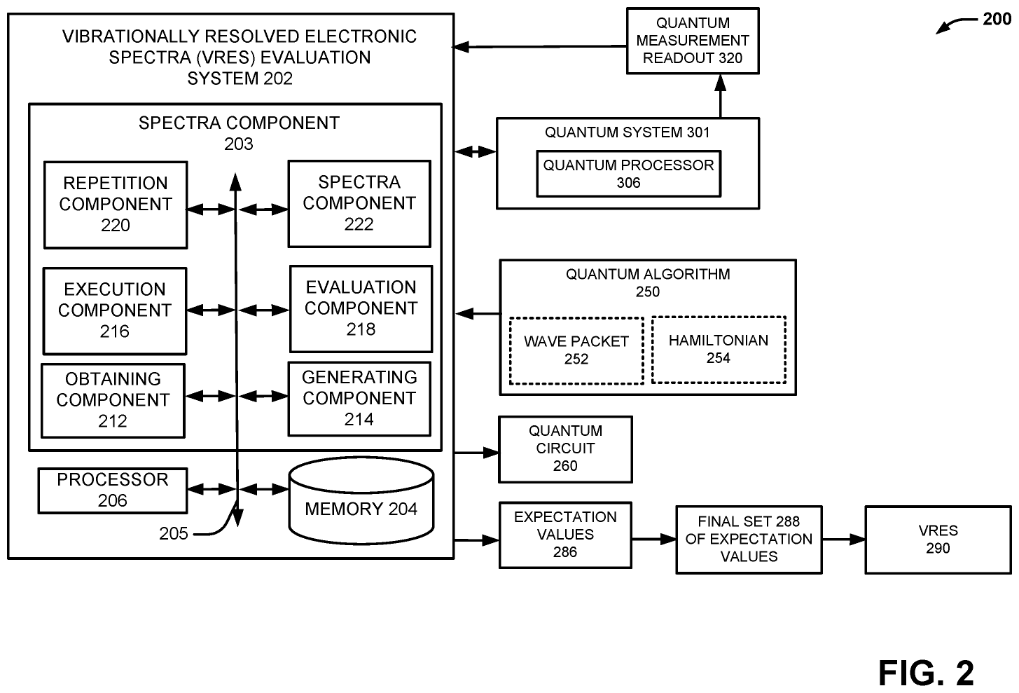

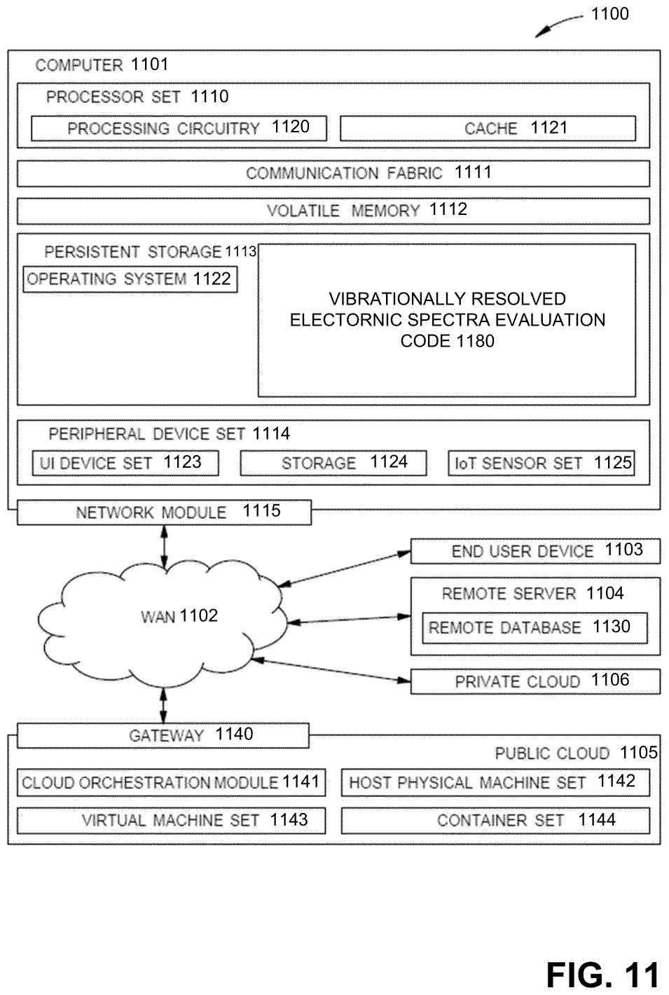

For example, in one or more embodiments, the non-limiting systems 100 and/or 200 illustrated at FIGS. 1 and 2, and/or systems thereof, can further comprise one or more computer and/or computing-based elements described herein with reference to a computing environment, such as the computing environment 1100 illustrated at FIG. 11. In one or more described embodiments, computer and/or computing-based elements can be used in connection with implementing one or more of the systems, devices, components and/or computer-implemented operations shown and/or described in connection with FIGS. 1 and/or 2 and/or with one or more other figures described herein.

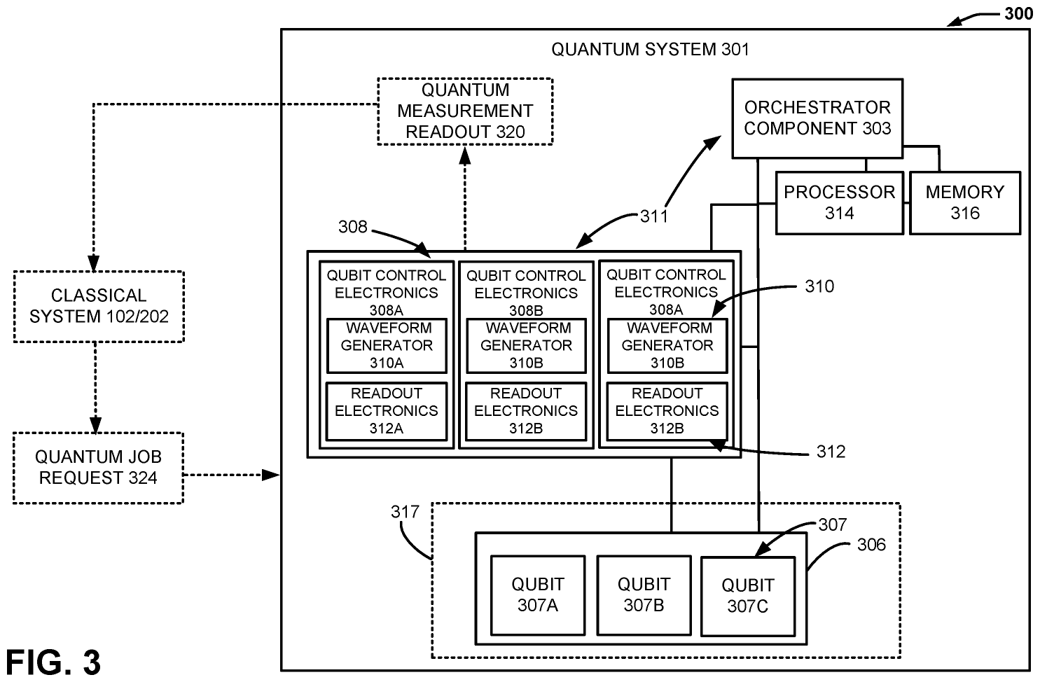

Turning now in particular to one or more figures, and first to FIG. 1, the figure illustrates a block diagram of an example, non-limiting system 100 that can determination of a vibrationally resolved electronic spectrum 190 of a molecule using both a classical vibrationally resolved electronic spectrum (VRES) evaluation system 102 and a quantum system 301 (FIG. 3).

That is, the non-limiting system 100 can comprise the VRES evaluation system 102 and the quantum system 301, to be described in detail below. It is noted that the VRES evaluation system 102 is only briefly described relative to FIG. 1 to provide but a lead-in to description of a more complex and/or more expansive vibrationally resolved electronic spectrum (VRES) system 202 as illustrated at FIG. 2. That is, further detail regarding processes that can be performed by one or more embodiments described herein will be provided below relative to the non-limiting system 200 of FIG. 2.

Still referring to FIG. 1, the VRES evaluation system 102 can comprise at least a memory 104, bus 105, processor 106, execution component 116 and/or evaluation component 118. Using these components and the quantum system 301, the VRES evaluation system 102 can provide for generation of a quantum algorithm 150 for being executed as a quantum circuit at the quantum system 301, employed the quantum processor 306, and resulting in an expectation value 186 that can be employed to derive/generate the VRES 190.

Generally, the execution component 116 can direct execution of a time dependent quantum algorithm 150 at the quantum processor 306 of the quantum system 301, wherein the quantum algorithm 150 comprises propagating a wave packet 152 in time under a determined Hamiltonian 154 (e.g., employing a determined harmonic approximation), resulting in a measurable output 320 at the quantum system 301, which can comprise one or more quantum computers. The wave packet 152 can comprise waves configured to execute a quantum circuit derived by the VRES evaluation system 102.

In response to execution of the quantum circuit at the quantum system 301, the evaluation component 118 generally can determine an expectation value 186 based on the output 320 and corresponding to a vibrationally resolved electronic spectrum 190 of a molecule. It is noted that the execution component 116 and/or the evaluation component 118 can operate at a classical system of and/or comprising the VRES evaluation system 102.

In one or more embodiments, the execution component 116 and/or the evaluation component 118 can be implemented independently, without the other of the execution component 116 and/or the evaluation component 118. Additionally and/or alternatively, the execution component 116 and/or the evaluation component 118 can be comprised by a high-level spectra component 103, the high-level spectra component 103 can perform one or more of the above-described functions of the execution component 116 and/or the evaluation component 118, and/or the execution component 116 and/or the evaluation component 118 can be omitted with the high-level spectra component 103 performing one or more of the above-described functions of the omitted execution component 116 and/or the evaluation component 118.

In general, the non-limiting system 100 can employ any suitable method of communication (e.g., electronic, communicative, internet, infrared, fiber, etc.) to provide communication between the classical system 102 and the quantum system 301.

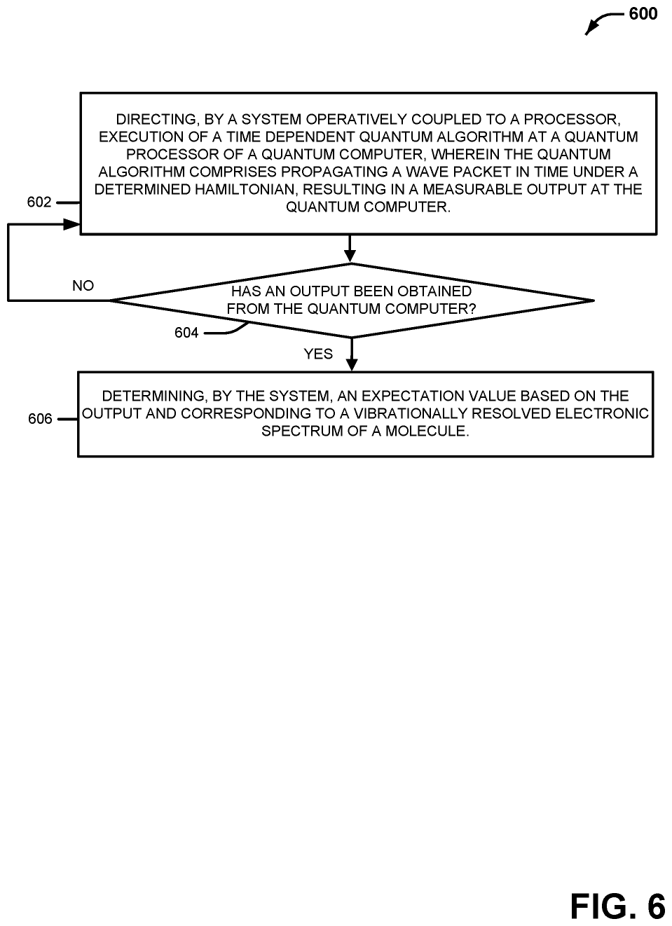

As a summary, referring next briefly to FIG. 6, illustrated is a flow diagram of an example, non-limiting method 600 that can provide a process to determine a VRES 190 for a molecule, in accordance with one or more embodiments described herein, such as the non-limiting system 100 of FIG. 1. Repetitive description of like elements and/or processes employed in respective embodiments is omitted for sake of brevity.

At 602, the non-limiting method 600 can comprise directing, by a system operatively coupled to a processor (e.g., execution component 114), execution of a time dependent quantum algorithm (e.g., quantum algorithm 250) at a quantum processor (e.g., quantum processor 306) of a quantum system (e.g., quantum system 301), resulting in a measurable output (e.g., quantum measurement readout 320) at the quantum system. The quantum algorithm 150 can comprise propagating a wave packet 152 in time under a determined Hamiltonian 154.

At 604, the non-limiting method 600 can comprise determining, by the system (e.g., quantum system 301 and/or evaluation component 118), whether an output has been obtained from the quantum system. If no, the non-limiting method 600 can return to step 602. If yes, the non-limiting method 600 can proceed to step 606.

At 606, the non-limiting method 600 can comprise determining, by the system (e.g., evaluation component 118), an expectation value (e.g., expectation value 186) corresponding to a VRES (e.g., VRES 190) of a molecule.

Turning next to FIG. 2, a non-limiting system 200 is illustrated that can comprise a VRES evaluation system 202. Repetitive description of like elements and/or processes employed in respective embodiments is omitted for sake of brevity. Description relative to an embodiment of FIG. 1 can be applicable to an embodiment of FIG. 2. Likewise, description relative to an embodiment of FIG. 2 can be applicable to an embodiment of FIG. 1.

Generally, the non-limiting system 200 can facilitate determination of a vibrationally resolved electronic spectrum 290 of a molecule using both a classical vibrationally resolved electronic spectra (VRES) evaluation system 202 and the quantum system 301 (FIG. 3).

Turning first to the VRES evaluation system 202, one or more communications between one or more components of the non-limiting system 200 can be provided by wired and/or wireless means including, but not limited to, employing a cellular network, a wide area network (WAN) (e.g., the Internet), and/or a local area network (LAN). Suitable wired or wireless technologies for supporting the communications can include, without being limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), high speed packet access (HSPA), Zigbee and other 802.XX wireless technologies and/or legacy telecommunication technologies, BLUETOOTH®, Session Initiation Protocol (SIP), ZIGBEE®, RF4CE protocol, WirelessHART protocol, 6LoWPAN (Ipv6 over Low power Wireless Area Networks), Z-Wave, an advanced and/or adaptive network technology (ANT), an ultra-wideband (UWB) standard protocol and/or other proprietary and/or non-proprietary communication protocols.

The VRES evaluation system 202 can be associated with, such as accessible via, a cloud computing environment.

The VRES evaluation system 202 can comprise a plurality of components. The components can comprise a memory 204, processor 206, bus 205, obtaining component 212, generating component 214, execution component 216, evaluation component 218, repetition component 220 and/or spectra component 222. Using these components, and using operation of the quantum system 301, the non-limiting system 200 generally can provide one or more quantum measurement readouts 320 that can be employed, by the one or more embodiments, to determine one or more expectation values 286, which in turn can be employed, by the one or more embodiments, to determine the VRES 290.

That is, the obtaining component 212, generating component 214, execution component 216, evaluation component 218, repetition component 220 and/or spectra component 222 can operate at the classical system 202 of the non-limiting system 200. One or more quantum circuits (e.g., quantum circuits 260) can be executed by the quantum system 301. In one or more other embodiments, one or more processes performed by any one or more of the obtaining component 212, generating component 214, execution component 216, evaluation component 218, repetition component 220 and/or spectra component 222 can be performed at the quantum system 301.

Discussion first turns briefly to the processor 206, memory 204 and bus 205 of the VRES evaluation system 202. For example, in one or more embodiments, the VRES evaluation system 202 can comprise the processor 206 (e.g., computer processing unit, microprocessor, classical processor, quantum processor and/or like processor). In one or more embodiments, a component associated with VRES evaluation system 202, as described herein with or without reference to the one or more figures of the one or more embodiments, can comprise one or more computer and/or machine readable, writable and/or executable components and/or instructions that can be executed by processor 206 to provide performance of one or more processes defined by such component and/or instruction. In one or more embodiments, the processor 206 can comprise the obtaining component 212, generating component 214, execution component 216, evaluation component 218, repetition component 220 and/or spectra component 222.

In one or more embodiments, the VRES evaluation system 202 can comprise the computer-readable memory 204 that can be operably connected to the processor 206. The memory 204 can store computer-executable instructions that, upon execution by the processor 206, can cause the processor 206 and/or one or more other components of the VRES evaluation system 202 (e.g., obtaining component 212, generating component 214, execution component 216, evaluation component 218, repetition component 220 and/or spectra component 222) to perform one or more actions. In one or more embodiments, the memory 204 can store computer-executable components (e.g., obtaining component 212, generating component 214, execution component 216, evaluation component 218, repetition component 220 and/or spectra component 222).

The VRES evaluation system 202 and/or a component thereof as described herein, can be communicatively, electrically, operatively, optically and/or otherwise coupled to one another via a bus 205. Bus 205 can comprise one or more of a memory bus, memory controller, peripheral bus, external bus, local bus, quantum bus and/or another type of bus that can employ one or more bus architectures. One or more of these examples of bus 205 can be employed.

In one or more embodiments, the VRES evaluation system 202 can be coupled (e.g., communicatively, electrically, operatively, optically and/or like function) to one or more external systems (e.g., a non-illustrated electrical output production system, one or more output targets and/or an output target controller), sources and/or devices (e.g., classical and/or quantum computing devices, communication devices and/or like devices), such as via a network. In one or more embodiments, one or more of the components of the VRES evaluation system 202 and/or of the non-limiting system 200 can reside in the cloud, and/or can reside locally in a local computing environment (e.g., at a specified location).

In general, the non-limiting system 200 can employ any suitable method of communication (e.g., electronic, communicative, internet, infrared, fiber, etc.) to provide communication between the VRES evaluation system 202 and the quantum system 301.

In addition to the processor 206 and/or memory 204 described above, the VRES evaluation system 202 can comprise one or more computer and/or machine readable, writable and/or executable components and/or instructions that, when executed by processor 206, can provide performance of one or more operations defined by such component and/or instruction.

Discussion next turns to the additional components of the VRES evaluation system 202 (e.g., obtaining component 212, generating component 214, execution component 216, evaluation component 218, repetition component 220 and/or spectra component 222).

First, it is noted that in one or more embodiments, the obtaining component 212, generating component 214, execution component 216, evaluation component 218, repetition component 220 and/or spectra component 222 can be implemented independently, without one or more other of the obtaining component 212, generating component 214, execution component 216, evaluation component 218, repetition component 220 and/or spectra component 222. Additionally and/or alternatively, the obtaining component 212, generating component 214, execution component 216, evaluation component 218, repetition component 220 and/or spectra component 222 can be comprised by a high-level spectra component 203, one or more of the below-described functions of the obtaining component 212, generating component 214, execution component 216, evaluation component 218, repetition component 220 and/or spectra component 222 can be performed by the high-level spectra component 203, and/or the obtaining component 212, generating component 214, execution component 216, evaluation component 218, repetition component 220 and/or spectra component 222 can be omitted with the high-level spectra component 203 performing one or more of the below-described functions of the one or more omitted obtaining component 212, generating component 214, execution component 216, evaluation component 218, repetition component 220 and/or spectra component 222.

Turning now specifically to the obtaining component 212, the obtaining component 212 generally can find, locate, determine, request, download, read and/or otherwise obtain information (e.g., data and/or metadata) relating to a molecule of interest, such as for which determination of a VRES 290 is desired. Likewise, the obtaining component 212 can find, locate, determine, request, download, read and/or otherwise obtain information (e.g., data and/or metadata) relating to various quantum circuit aspects, such as a Hadamard test, and/or related to the physical qubits of the quantum processor 306 (e.g., a physical qubit hardware mapping).

Based on the one or more processes of the obtaining component 212, the generating component 214 generally can generate the quantum algorithm 250 and thus also the quantum circuit 260 based on the quantum algorithm 250.

Generally, the execution component 216 can direct execution of the time dependent quantum algorithm 250 at the quantum processor 306 of the quantum system 301, wherein the quantum algorithm 150 comprises propagating a wave packet 152 in time under a determined Hamiltonian 154, resulting in a measurable output 320 at the quantum system 301. The wave packet 152 can comprise waves configured to execute a quantum circuit derived by the VRES evaluation system 102. As noted above, the time dependent algorithm can be configured to simulate a time evolution with the Hamiltonian 254.

Next, prior to a detailed discussion of the quantum algorithm 250 and quantum circuit 260, in addition to detailed discussion of generation of the VRES 290, discussion first turns to a general description of an exemplary quantum system 301 that can be employed to provide execution of the quantum circuit 260 in connection with the classical system 202.

Turning to FIG. 3, one or more embodiments described herein can include one or more devices, systems and/or apparatuses that can provide a process to generate one or more waveforms or pulses for a quantum-based operation (e.g., using a quantum device), such as for operating one or more qubits of a quantum device. Accordingly, at FIG. 3, illustrated is a block diagram of an example, non-limiting system 300 that can at least partially facilitate such a process. While referring here to one or more processes, facilitations and/or uses of the non-limiting system 300, description provided herein, both above and below, also can be relevant to one or more other non-limiting systems described herein, such as the non-limiting systems 100 and/or 200.

As illustrated at FIG. 3, the non-limiting system 300 can comprise a quantum system 301 that can be employed with or separate from the classical systems 102/202.

Generally, the quantum system 301 (e.g., quantum computer system, superconducting quantum computer system and/or the like) can employ quantum algorithms and/or quantum circuitry, including computing components and/or devices, to perform quantum operations and/or functions on input data to produce results that can be output to an entity. The quantum circuitry can comprise quantum bits (qubits), such as multi-bit qubits, physical circuit level components, high level components and/or functions. The quantum circuitry can comprise physical pulses that can be structured (e.g., arranged and/or designed) to perform desired quantum functions and/or computations on data (e.g., input data and/or intermediate data derived from input data) to produce one or more quantum results as an output. The quantum results, e.g., quantum measurement readout 320, can be responsive to the quantum job request 324 and associated input data and can be based at least in part on the input data, quantum functions and/or quantum computations.

In one or more embodiments, the quantum system 301 can comprise components, such as an orchestrator component 303, a quantum processor 306, pulse component (e.g., a waveform generator 310) and/or a readout electronics 312 (e.g., readout component).

The quantum processor 306 can comprise one or more, such as plural, qubits 307. Individual qubits 307A, 307B and 307C, for example, can be fixed frequency and/or single junction qubits, such as transmon qubits.

In one or more embodiments, a readout resonator can be associated with, such as located with physical hardware defining a qubit 307.

In one or more embodiments, a memory 316 and/or processor 314 can be associated with the orchestrator component 303, where suitable. The processor 314 can be any suitable processor. The processor 314 can generate one or more instructions for controlling the one or more processes of the orchestrator component 303, such as for controlling one or more subordinate controllers (e.g., qubit control electronics 308).

The orchestrator component 303 can obtain (e.g., download, receive, search for and/or the like) a quantum job request 324 requesting execution of one or more quantum programs and/or a physical qubit layout. The quantum job request 324 can be provided in any suitable format, such as a text format, binary format and/or another suitable format. In one or more embodiments, the quantum job request 324 can be obtained by a component other than of the quantum system 301, such as a by a component of the classical systems 102/202.

The orchestrator component 303 can determine mapping of one or more quantum logic circuits for executing a quantum program. In one or more embodiments, the orchestrator component 303 and/or quantum processor 306 can direct the waveform generator 310 to generate one or more pulses, tones, waveforms and/or the like to affect one or more qubits 307, such as in response to a quantum job request 324.

In one or more embodiments, more than one orchestrator component 303 can be comprised by the quantum system 301. The one or more orchestrator components 303 can be employed to control one or more qubit control electronics 308. Thus, the one or more qubit control electronics 308A, 308B and/or 308C can be communicatively coupled to the one or more orchestrator components 303.

Qubit control electronics 308 can be employed by the quantum processor 306 and disposed within a room temperature environment external to the cryogenic environment 317, as illustrated. In one or more embodiments, one or more aspects of one or more qubit control electronics can be disposed within a cryogenic environment 317.

In one or more embodiments a qubit control electronics 308 can be provided per qubit 307. In one or more embodiments, a qubit control electronics 308 can be provided to communicate with more than one qubit 307 per that qubit control electronics 308.

In one or more embodiments, a qubit control electronics 308 can be and/or can comprise a qubit drive card (e.g., a waveform generator 310) and/or a qubit acquire card (e.g., readout electronics 312). In one or more embodiments, a qubit control electronics 308 can be and/or can comprise only one of a qubit drive card or a qubit acquire card. In one or more embodiments, a qubit control electronics 308 can comprise more than one qubit drive card and/or more than one qubit acquire card.

A waveform generator 310 generally can cause at least one qubit 307 of the quantum processor 306 to perform one or more quantum processes, calculations and/or measurements by creating a suitable electro-magnetic signal. For example, the waveform generator 310 can operate one or more qubit effectors, such as qubit oscillators, harmonic oscillators, pulse generators and/or the like to cause one or more pulses to stimulate and/or manipulate the state(s) of the one or more qubits 307 comprised by the quantum system 301. Indeed, a signal can be generated by the waveform generator 310 to affect one or more of the plurality of qubits 307.

In one or more embodiments, the waveform generator 310 can direct application of such electro-magnetic signal by use of the various qubit control electronics 308.

The quantum processor 306 can be contained in a cryogenic environment, such as generated by a cryogenic environment 317, such as effected by a dilution refrigerator. Where the plurality of qubits 307 are superconducting qubits, cryogenic temperatures, such as about 4K or lower, can be employed for function of these physical qubits.

The readout electronics 312 can comprise and/or be comprised by the acquire card. The readout electronics 312 and/or the acquire card can comprise an analog to digital converter (ADC) 315 that can be employed for the readout path of one or more qubits 307. The readout electronics 312, or at least a portion thereof, can be contained in a room temperature environment or the cryogenic environment 317, such as for reading a state, frequency and/or other characteristic of qubit, excited, decaying or otherwise. Accordingly, one or more elements of the readout electronics 312 also can be constructed to perform at such cryogenic temperatures.

In one or more embodiments, more than one cryogenic environment, such as more than one dilution refrigerator, can be comprised by the quantum system 301.

It is noted that one or more aspects of the aforementioned description can refer to operation of a single set of instructions run on a single qubit controller or set of qubit control electronics. However, scaling can be achieved. For example, instructions can be calculated, transmitted, employed and/or otherwise used relative to one or more qubits (e.g., non-neighbor qubits) in parallel with one another, one or more quantum circuits in parallel with one another, and/or one or more qubit mappings in parallel with one another.

Turning now back to FIG. 2 in addition to still referring to FIG. 3, discussion turns to one or more processes performed by one or more additional components of the VRES evaluation system 202, and more particularly to continuation of description of the quantum algorithm 250 and quantum circuit 260 for execution at the quantum system 301 as described above.

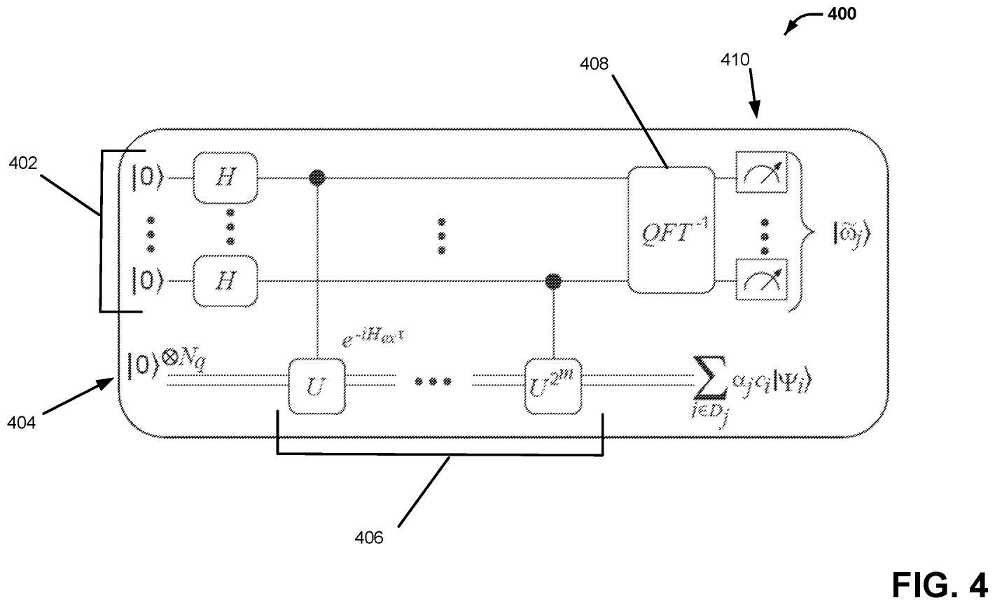

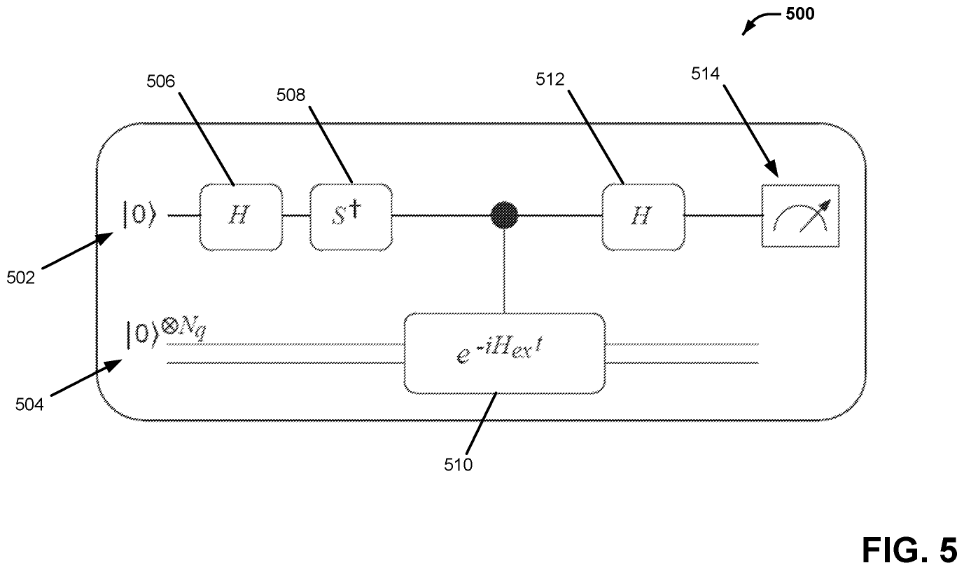

Turning first to FIG. 4, illustrated is a schematic diagram of an exemplary quantum circuit 400 of a conventional approach using quantum phase estimation (QPE), which is illustrated to highlight one or more benefits of the quantum circuit 260 to be described next relative to FIG. 5. That is, use of QPE can require employment of both a plurality of ancilla/control qubits 402 and a plurality of data qubits 404. Due to the use of the plurality of control qubits 402, the quantum circuit 400 is deep and long, requiring execution of numerous gates related to a plurality of unitaries 406, the number of which can increase exponentially relative to increase in molecule size. In connection therewith the quantum circuit aspect 408, representing a fault tolerant quantum algorithm, and executed as a quantum fault tolerant sub-circuit (QFT⁻¹ sub-circuit), is a deep and complex quantum circuit in itself. Execution of these unitaries 406 and the circuit aspect 408 is not only overly-time consuming, overly-energy consuming, overly-resource consuming and complex, but also can be impossible with larger molecules due to limitations of current and/or near-term quantum systems. Furthermore, as a result of the above, execution of determination of a measurement readout requires measurement of a full set of qubits of a particular bitstring 410 to get energy |\tilde{ω}ⱼ [symbol] , which is both complex and inefficient, and in some cases, can be impossible with larger molecules due to limitations of current and/or near-term quantum systems.

Turning next to FIG. 5, in addition to still referring to FIGS. 2 and 3, is a schematic diagram of an exemplary quantum circuit 500 that can be based on the quantum algorithm 250 and generated by the generating component 214. First, differently from the approach of FIG. 5, the framework described herein can employ a single control/ancilla qubit 502 along with one or more data qubits 504. In connection therewith, a single controlled gate 510 can be employed, rather than a plurality of gates related to a plurality of exponentially-increasing (relative to increase in molecule size) unitaries. Also, in connection therewith, determination and/or output of a measurement readout 320 can comprise a single measurement 514 (e.g., in a respective Z-basis) of a state of the single ancilla/control qubit 502, rather than ordered measurement relative to a complex bitstring. More particularly, generation of the time dependent quantum algorithm 250 by the generating component 214 can comprise generating the quantum circuit 260 corresponding to the time dependent quantum algorithm 250, wherein the quantum circuit 260 employs the data qubit 504 and the ancilla qubit 502 of the quantum processor 306 (e.g., qubits 307) of the quantum system 301.

Generally, the intent of the quantum algorithm 250 can be to return a value of a(t), which represents an autocorrelation function, e.g., defining how data points in a time series are related, e.g., on average, to preceding data points. As used herein, the function a(t) can refer to an overlap of a first respective wave function at time t=0 with a second respective wavefunction at time t=t. That is, the wavefunction is being autocorrelated via the autocorrelation function.

Moreover, the quantum algorithm 250 can be modified for varying values of time t, thereby returning varying values of a(t), which can be aggregated or grouped. The final set 288 of expectation values a(t) can be employed to generate a set of quantities of interest, σ(ω), where ω is frequency, and where σ(ω) represents a profile for the molecule of interest, which can be represented as a vibronic spectrum (e.g., VRES 290). The output of the algorithm is a vibronic spectrum which is a function α having a parameter ω. Physically, the function σ(ω) is the overlap of an eigenstate (with eigenvalue ω) of a respective Hamiltonian after an electronic transition, with a ground state of the Hamiltonian being before the electronic transition.

First, it is appreciated that the generating component 214, in connection with generation of the quantum algorithm 250/quantum circuit 260, can determine a set of time factors t to employ at different quantum algorithms 250 (of a set of quantum algorithms differing only with respect to t) to achieve generation of the VRES 290.

For example, the generating component 214 can discretize time t and frequency ω to set up a time and frequency grid, the values of which are denoted by t_{gr} and ω_{gr}. It is noted that t_{gr} is inversely proportional to the ω_{gr}. The discrete frequencies ω_{gr} can be discretized linearly between the lowest and highest harmonic frequencies. Because anharmonic frequencies lie below their harmonic counterparts the grid creation using this approach can ensure that anharmonic frequencies are included. The number of grid points N is inversely proportional to the target spectral accuracy, i.e. N can scale as

$$O ( \frac{1}{δ ω} ) ,$$

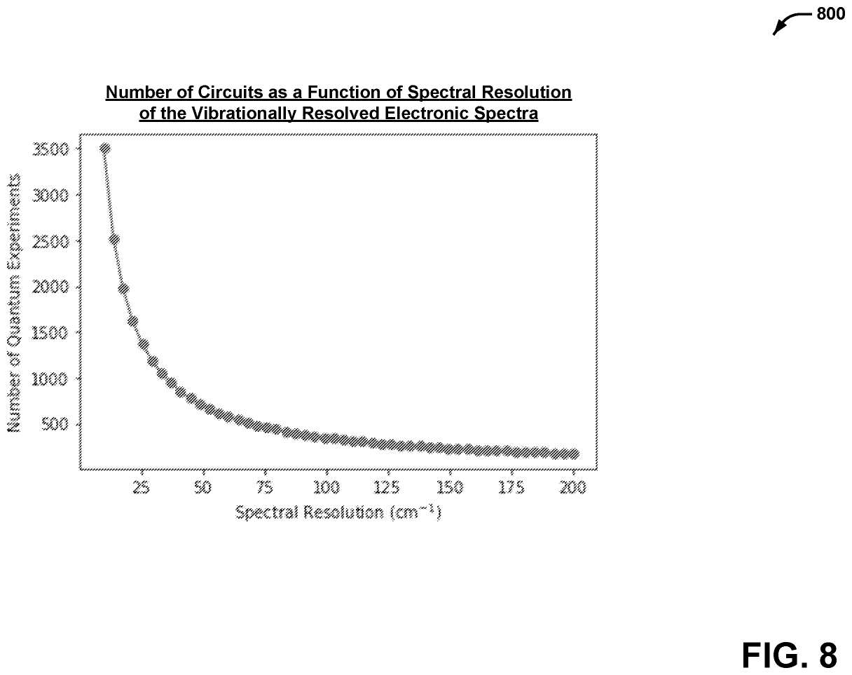

as illustrated at FIG. 8, depicting t_{gr} on the x-axis and ω_{gr} on the y-axis. Here, δω is spectral resolution and O represents a term as being proportional to, in the asymptotic limit. In one or more embodiments, N can be equal to a number of total shots for all values of t. For each value of time t in the t_{gr}, the quantum algorithm can be executed and the auto-correlation function a(t) calculated at that time, as will be explained below.

$$N = O ( \frac{1}{δ ω} ) \qquad Equation 3$$

Turning next to generation of the quantum algorithm 250 and of the quantum circuit 260, the generating of the quantum algorithm 250 and respective quantum circuit 260 can comprise including a first performance 506 of a Hadamard gate H on the ancilla qubit wire 502 and a subsequent controlled e^{-iH}^{ₑₓ}^{t} gate 510 at the data qubit wire 504 and the ancilla qubit wire 502. Relative to the controlled gate 510, H refers to Hamiltonian, i refers to the conventional complex number i and the sub “ex” is short for “excited” and refers to the Hamiltonian of the vibrational part of the specified molecule after an electronic transition in question.

To implement the Hadamard test, two quantum registers can be employed, as illustrated at 508 and 512 of FIG. 5, with one to store the vibrational quantum state and one to readout the auto-correlation function a(t). As noted above generally, at FIG. 5, the upper wire is the ancillary qubit 502 and the lower wire represents the register of the one or more data qubits 504. It is noted that because vibronic spectra are being calculated at zero temperature, the quantum state being employed is a vacuum state and thus does not require any state preparation steps. More precisely, the initial state can be given by |0 [symbol] ^{⊗}^{^{L}} where L is the number of qubits. Additionally, and/or alternatively, one could consider finite temperature by preparing the initial state as a thermal distribution at a particular temperature.

The Hadamard gate H acts on the ancillary qubit to create an equal superposition of the |0 [symbol] and |1 [symbol] state.

Next, a controlled gate 510 can be included in the quantum circuit 260, with a control on the ancillary qubit 502. Here, the H refers to Hamiltonian and not to any Hadamard register. Both are conventional variable uses. In one or more embodiments, the second order Trotter-Suzuki decomposition can be employed to implement the controlled e^{-iHt} gate 510 (e.g., propagator e^{-iHt}).

The controlled gate 510 serves as a controlled version of a time evolution operator, allowing for entanglement of the time evolved initial state with the phase difference in the ancilla qubit 502. It is noted that the phase difference can generally aid in obtaining the autocorrelation function a(t). The controlled gate 510 is parameterized based on a selected time factor t that can be selected by the generating component 214 and/or by an administrating entity associated with the non-limiting system 200.

Finally, an additional Hadamard gate can be employed at the quantum circuit 260, to the ancillary qubit 502 and this qubit can be measured in the σZ basis. That is, the generating further can comprise inclusion of a second performance 512 of a Hadamard gate H at the ancilla qubit wire 502, following the controlled gate 510, and a final measurement 514 of the ancilla qubit 502 in a respective Z-basis.

It further is noted that if for any additional reason the imaginary part of a(t) is desired, for each different time factor t, an additional S^{†} gate 508 can be added to the ancilla qubit wire 502 at each respective different quantum circuit 260. That is, the phase gate S† can be employed in the quantum circuit 260 by the generating component 214, if desired, to calculate the imaginary part of a(t). Alternatively, phase gate S† can left out if an aim is to calculate the real part of a(t). In particular, for Re(a(t))→α=0 and Im(a(t))→α=1. The additional S^{†} gate 508 can be a one-qubit gate that can be written in terms of rotation angles and which can represent a respective 2×2 matrix of rotation gates on the one qubit (here the ancilla qubit 502). However, it is appreciated that the one or more frameworks discussed herein do not require the use of the additional gate 508, which can be omitted without other alteration to the quantum circuit 260 (e.g., without other alteration to the exemplary quantum circuit schematic diagram 500 of FIG. 5).

As a result of the one or more processes performed by the generating component 214, data defining the wave packet 252, which provides for execution of the set of gates of the quantum circuit 260, can be generated by the execution component 216 and/or by the orchestrator component 303 upon sending of a respective quantum job request 324 to the quantum system 301.

That is, the execution component 215 can direct the execution of the quantum circuit 260 corresponding to the time dependent quantum algorithm 250, comprising propagating the wave packet 252 in time under the determined Hamiltonian 254 (e.g., employing a determined harmonic approximation and appearing as the controlled gate 510), where the quantum circuit 260 employs the data qubit 504 and the ancilla qubit 502. The directing comprises directing performance of a set of gates or the wave packet 252 comprising a Hadamard gate H on the ancilla qubit 502, subsequent performance of a controlled e^{-iHt} gate 510 employing the data qubit 504 and the ancilla qubit 502, a second performance 512 of a Hadamard gate on the ancilla qubit 502, and subsequent measuring of the ancilla qubit 502 in the Z-basis.

In association with a quantum job request 324 comprising the information regarding the quantum circuit 260, and thus defining the wave packet 252, the orchestrator component 303 can direct initialization of states of the qubits 307 to be employed. That is, the qubits 307 to be initialized are those to which the ancilla qubit 502 and the one or more data qubits 504 of the quantum circuit 260 are mapped. The mapping can be at least partially performed by the execution component 216 and/or by the orchestrator component 303, for example.

The initialization of the ground states of the respective qubits 307 is magnitudes simpler in the one or more frameworks discussed herein, as compared to conventional frameworks. As noted above, this is because the one or more frameworks discussed herein employ a ground state of zero for each of the qubits being employed. That is, the one or more frameworks discussed herein employ a ground state of a harmonic Hamiltonian, which are set to zero for each qubit being employed. Therefore, inherent to the one or more frameworks themselves, determination of a VRES 290 of a molecule of interest is made substantially simpler.

Subsequent to the initialization, execution of the quantum circuit 260 can be fulfilled at the quantum system 301, such as by the orchestrator component 303, by employing the quantum processor 306 and the initialized set of qubits 307 therein.

The execution of the quantum circuit 260 at the quantum system 301 can comprise employing the wave packet 252 to affect the initialized set of qubits 307, resulting in the measurable state of the ancilla qubit 502 and subsequent output of the measurement readout/output 320 by the quantum system 301. It is noted that the measuring of the ancilla qubit in the Z-basis, is the same (e.g., being for only a single ancilla qubit 502) regardless of a number of data qubits, including the data qubit 504, to be employed to execute the quantum circuit 260 and regardless of a qubit depth of the quantum circuit 260.

The expectation value of αZ can give either the real or imaginary part of a(t), depending on whether we take α=0 or α=1 respectively. These steps are set forth in Algorithm I, provided below. Note that the number of qubits employed during each execution of the Hadamard test does not change as a function of the target spectral resolution. This is in contrast to a conventional QPE based algorithm.

Algorithm I: Quantum Algorithm for Vibronic Spectra:
Require: : Hₑₓ, min(Ωₑₓ), max(Ωₑₓ) Prepare: w_{grd}, t_{grd}
Ensure: Δw ≤ 50 cm⁻¹
|0 [symbol] _{A} |0 [symbol] _{S}
$\frac{1}{\sqrt{2}} ( \vert 0 {〉}_{A} + \vert 1 {〉}_{A} ) \vert 0 {〉}_{S}$
$\frac{1}{\sqrt{2}} ( \vert 0 {〉}_{A} \vert 0 {〉}_{S} + exp - {iH}_{ex} t \vert 1 {〉}_{A} ) \vert 0 {〉}_{S}$

Discussion now turns to the evaluation component 218, which generally can determine an expectation value 286 based on the output 320 and corresponding to a vibrationally resolved electronic spectrum 290 of the molecule of interest. This determining can comprise evaluating P(0), the probability of the measurement of the ancilla qubit 502 being 0, and/or P(1), the probability of the measurement of the ancilla qubit 502 being 1 to obtain quantity a(t) for the particular time factor t that was employed for the executed quantum algorithm 250/quantum circuit 260. This evaluation generally can assume that a plurality of shots of the same quantum circuit execution were performed (e.g., repeated), with the results of the plurality of shots being a quantity of 0's and a quantity of 1's. In connection therewith, information about the expectation value a(t), such as the real part of a(t), can be extracted from P(0) or P(1), where P(0)=1−(P1). To extract the real part of a(t), Equation 1 can be employed. As noted above, the quantity a(t) is the expectation value 286 for that particular quantum circuit execution and also the autocorrelation function for that particular quantum circuit execution.

$$P ( 0 ) = \frac{1}{4} {\vert {\sum }_{i} {C}_{i} {e}^{- i {ω}_{i} t} {ψ}_{i} + 1000 … > \vert}^{2} = \frac{1}{2} ( 1 + Re ( a ) ) \qquad Equation 1$$

Next, the repetition component 220 can determine whether additional time factors t are to be evaluated, and thus determine an associated cycle number. That is, based on the cycle number corresponding to a quantity of different time factors t to be employed for different quantum algorithms 250, including the initial quantum algorithm 250, the repetition component 220 can direct repetition a number of times equal to the cycle number, of the processes performed by the execution component 216 and the evaluation component 218.

It is noted that for each cycle, e.g., per different time factor t, including an initial cycle, a plurality of shots (e.g., repeated executions of a same quantum circuit/same quantum execution) can be executed.

In connection with more than one cycle being performed, the evaluation component 218 can aggregate and/or group the expectation values 286 resulting from the execution of the set of modified quantum circuits 285 to generate a final set 288 of expectation values 286 which can be employed by the evaluation component 218.

Using the final set 288 of expectation values 286, being a set of quantities a(t), the evaluation component 218 can classically execute a Fourier transform of the autocorrelation function, F(a(t)). An exemplary Equation 3 illustrates the aforediscussed relationship between σ(ω) and a(t).

$$\begin{matrix}σ ( ω ) & = {\int }_{- ∞}^{∞} {e}^{i ω t} 〈 {ψ}_{0} \vert {e}^{- iHt} \vert {ψ}_{0} 〉 dt \\ & = F ( 〈 {ψ}_{0} \vert {ψ}_{t} 〉 ) = F ( a ( t ) )\end{matrix} \qquad Equation 3$$

Based on the result of Equation 1, the spectra component 222 can generally generate the VRES 290 having various peaks defining the molecule of interest. That is, the function a(t) is taken as an input to a standard Fast Fourier Transform algorithm. The output of this algorithm is the function σ(ω), the overlap of an eigenstate (with eigenvalue omega) of the Hamiltonian after the electronic transition, with the ground state of the Hamiltonian before the electronic transition.

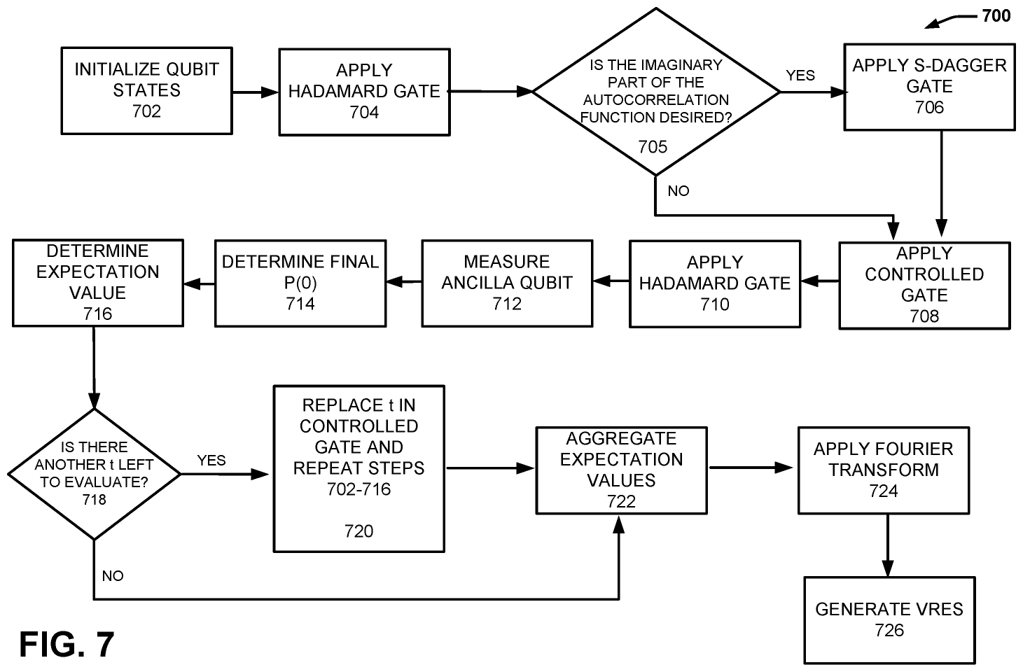

Turning now to FIG. 7, illustrated is a schematic diagram summarizing various processes that can be performed by the non-limiting system 200, as described above. As a brief summary, and starting after receipt of the quantum job request 324 at the quantum system 301, the quantum system can first initialize qubit states at step 702. As noted above, these grounds states are zero for the ancilla qubit 502 and for all one or more data qubits 504. A first performance 506 of a Hadamard gate is applied to the ancilla qubit 502 at step 704. At step 705, a determination can be made, such as by the generating component, as to whether the imaginary part of the autocorrelation function is desired. If yes, the S^{†} gate can be applied to the ancilla qubit 502 at step 706. Otherwise, if no, the processes can proceed to step 708 to application of the controlled gate 510. A second performance 512 of a Hadamard gate is applied to the ancilla qubit 502 at step 710. Finally, as a final step at the quantum system 301, the ancilla qubit 502 can be measured in the Z-basis. It is noted that steps 702 through 710 are performed at the quantum system 301. Differently, prior steps of generation of the quantum circuit 260 and directing of execution of the quantum circuit 260 (e.g., via generation of the quantum job request 324) are performed at the classical side of the non-limiting system 200.

From results of a plurality of shots of repeating the same wave packet 252, a final P(0) can be determined for the particular time factor t at step 714. This counting step can be performed at the quantum system 301 and/or at the classical system 202. Using P(0), a real part of the first autocorrelation function a(t) can be obtained at step 716 at the quantum system 301 and/or at the classical system 202. Put another way, the expectation value 286 associated with the particular time factor t can be determined.

At step 718, the repetition component 220 (of the classical system 202) can determine if there is another time factor t left to evaluate. If yes, the processes can proceed to step 720, where the generating component 214 (classical system) can replace t in the controlled gate 510 and the execution component 216 can issue a respective quantum job request 324. If no, the processes can proceed instead to step 722. It is noted that steps 718 and 720 can be performed before, during and/or after execution of any cycle at the quantum system 301. For example, different than the linear order of steps illustrated at FIG. 7, a quantum job request 324 can comprise information regarding two or more quantum circuits 260 (e.g., being the same other than for different time factors t.

At step 722, the set 288 of expectation values 286 for each of the different time factors t can be aggregated or grouped. That is, for each discrete value of time t, a different scalar value for a(t) is obtained. For each value of t, a corresponding value of a can be stored, such as by the evaluation component 218, such as at the memory 204 or other location communicatively accessible to the VRES evaluation system 202.

At step 724, a vibronic profile for the molecule of interest can be obtained by taking a Fourier transform of the final expectation value (e.g., F(a(t))). Finally, at step 726, the VRES can be visually generated, being a visual representation of the vibronic profile. It is noted that steps 722 through 726 can be performed at the classical system 202.

At FIG. 8, illustrated is a graph 800 graphically illustrating a number of quantum circuits 260 performed (e.g., number of different t factors employed) as a function of spectral resolution relative of the VRES 290. As illustrated, a target spectral resolution of 50 cm⁻¹ can be achieved with an acceptable number of quantum experiments (e.g., quantum circuits) numbering between 500 and 1000. The target is presently defined as an industry accepted spectral resolution.

It is noted that a similar graph for a conventional framework, such as using quantum phase estimation, would instead employ “number of control qubits” as a y-axis unit, and thus quantity of executions would be significantly increased across the board, regardless of spectral resolution, as compared to the one or more frameworks described herein. Further, the approximations regarding a Hilbert space taken in conventional approaches can result in resonance peaks of an associated spectra not being within 50 cm⁻¹ of the true peaks for the molecule of interest, but rather being shifted.

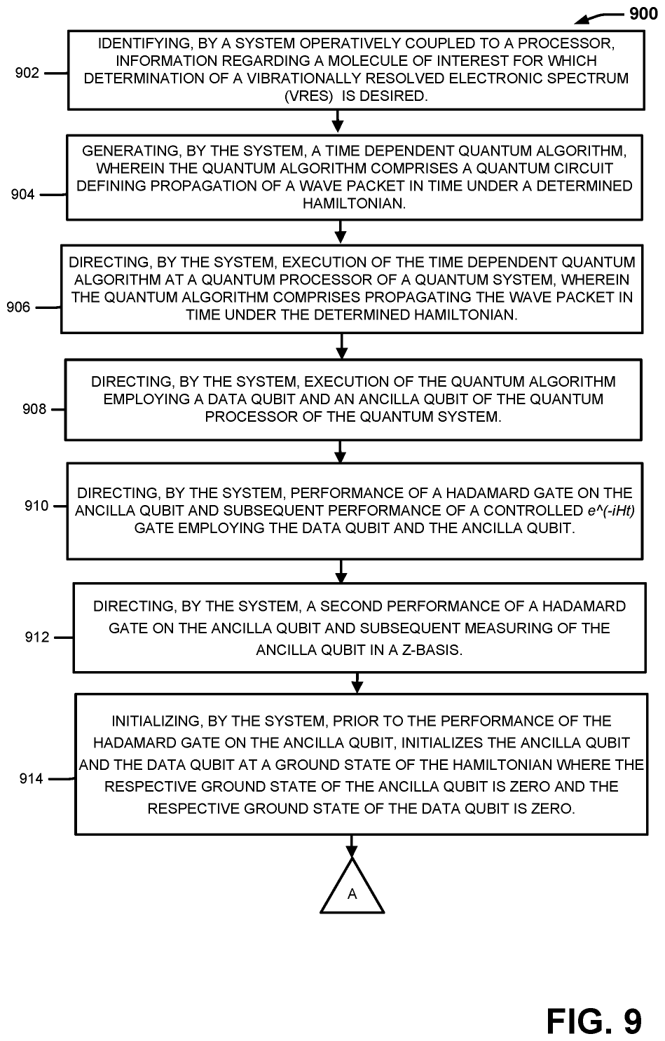

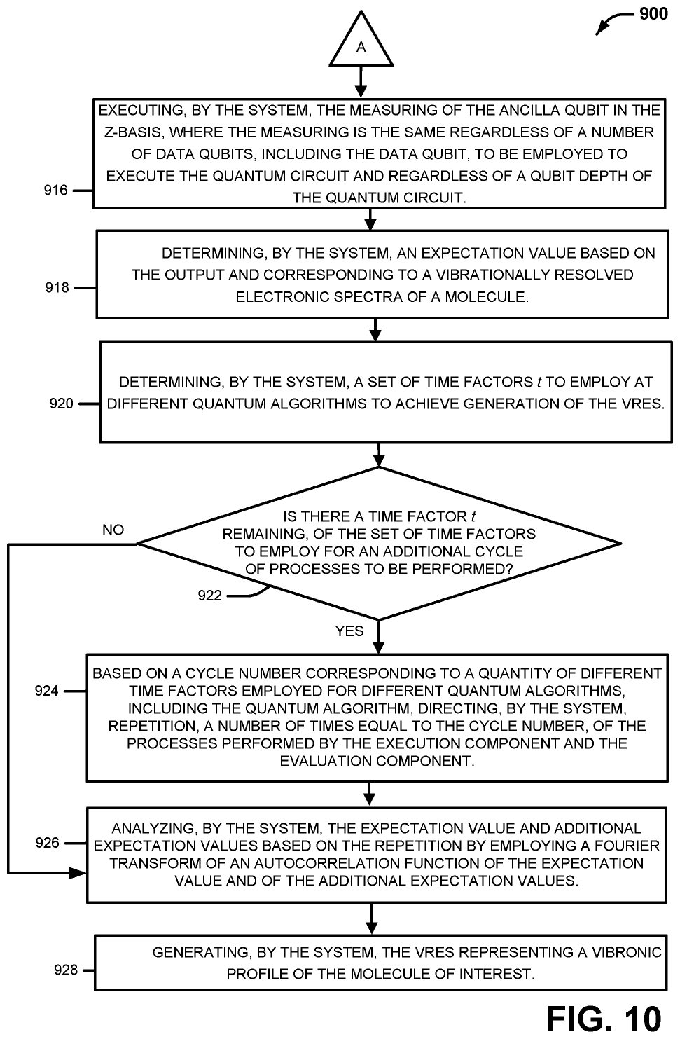

As a summary, referring next to FIGS. 9 and 10, illustrated is a flow diagram of an example, non-limiting method 900 that can provide a process to determine a vibronic spectra for a specified molecule, in accordance with one or more embodiments described herein, such as the non-limiting system 200 of FIG. 2. While the non-limiting method 900 is described relative to the non-limiting system 200 of FIG. 2, the non-limiting method 900 can be applicable also to other systems described herein, such as the non-limiting system 100 of FIG. 1. Repetitive description of like elements and/or processes employed in respective embodiments is omitted for sake of brevity.

At 902, the non-limiting method 900 can comprise identifying, by a system operatively coupled to a processor (e.g., obtaining component 212), information regarding a molecule of interest for which determination of a vibrationally resolved electronic spectrum (VRES) (e.g., VRES 290) is desired.

At 904, the non-limiting method 900 can comprise generating, by the system (e.g., generating component 214), a time dependent quantum algorithm (e.g., quantum algorithm 250), wherein the quantum algorithm comprises a quantum circuit (e.g., quantum circuit 260) defining propagation of a wave packet (e.g., wave packet 252) in time under a determined Hamiltonian (e.g., Hamiltonian 254).

At 906, the non-limiting method 900 can comprise directing, by the system (e.g., execution component 216), execution of the time dependent quantum algorithm at a quantum processor (e.g., quantum processor 306) of a quantum system (e.g., quantum system 301), wherein the quantum algorithm comprises propagating the wave packet in time under the determined Hamiltonian.

At 908, the non-limiting method 900 can comprise directing, by the system (e.g., execution component 216), execution of the quantum algorithm employing a data qubit and an ancilla qubit of the quantum processor of the quantum system.

At 910, the non-limiting method 900 can comprise directing, by the system (e.g., execution component 216), performance (e.g., first performance 506) of a Hadamard gate (e.g., Hadamard gate H) on the ancilla qubit and subsequent performance of a controlled e^{-iHt} gate (e.g., controlled gate 510) employing the data qubit and the ancilla qubit.

At 912, the non-limiting method 900 can comprise directing, by the system (e.g., execution component 216), a second performance (e.g., second performance 512) of a Hadamard gate on the ancilla qubit and subsequent measuring of the ancilla qubit in a Z-basis.

At 914, the non-limiting method 900 can comprise initializing, by the system (e.g., orchestrator component 203), prior to the performance of the Hadamard gate on the ancilla qubit, initializes the ancilla qubit and the data qubit at a ground state of a harmonic Hamiltonian where the respective ground state of the ancilla qubit is zero and the respective ground state of the data qubit is zero.

At 916, the non-limiting method 900 can comprise executing, by the system (e.g., qubit control electronics 308), the measuring of the ancilla qubit in the Z-basis, where the measuring is the same (e.g., being for only a single ancilla qubit) regardless of a number of data qubits, including the data qubit, to be employed to execute the quantum circuit and regardless of a qubit depth of the quantum circuit.

At 918, the non-limiting method 900 can comprise determining, by the system (e.g., evaluation component 218), an expectation value (e.g., expectation value 286) based on the output and corresponding to a vibrationally resolved electronic spectrum (e.g., VRES 290) of a molecule.

At 920, the non-limiting method 900 can comprise determining, by the system (e.g., generating component 214), a set of time factors t to employ at different quantum algorithms to achieve generation of the VRES.

At 922, the non-limiting method 900 can comprise determining, by the system (e.g., repetition component 220), whether there is a time factor t remaining, of the set of time factors, to employ for an additional cycle of processes to be performed by the non-limiting system 200. If yes, the non-limiting method 900 can proceed to step 924. If no, the non-limiting method 900 can proceed to step 926.

At 924, the non-limiting method 900 can comprise based on a cycle number corresponding to a quantity of different time factors employed for different quantum algorithms, including the quantum algorithm, directing, by the system (e.g., repetition component 220), repetition, a number of times equal to the cycle number (e.g., N), of the processes performed by the execution component and the evaluation component.

At 926, the non-limiting method 900 can comprise analyzing, by the system (e.g., evaluation component 218), the expectation value and additional expectation values based on the repetition by employing a Fourier transform of an autocorrelation function (e.g., F(a(t))) of the expectation value (e.g., a(t)) and of the additional expectation values.

At 928, the non-limiting method 900 can comprise generating, by the system (e.g., spectra component 222), the VRES representing a vibronic profile of the molecule of interest.

### ADDITIONAL SUMMARY

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. In addition, the computer-implemented and non-computer-implemented methodologies could alternatively be represented as a series of interrelated states via a state diagram or events. Additionally, the computer-implemented methodologies described hereinafter and throughout this specification are capable of being stored on an article of manufacture for transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

In summary, the one or more embodiments described herein can provide a system, computer-implemented method and/or computer program product to determine a vibrationally resolved electronic spectrum of a molecule. A system 100, 200 comprises a memory 104, 204 that stores computer executable components, and a processor 106, 206 that executes the computer executable components stored in the memory 104, 204, wherein the computer executable components comprise: an execution component 116, 216 that directs execution of a time dependent quantum algorithm 150, 250 at a quantum processor 306 of a quantum system 301, wherein the quantum algorithm 150, 250 comprises propagating a wave packet 152, 252 in time under a determined Hamiltonian 154, 254, resulting in a measurable output 320 at the quantum system 301, and an evaluation component 118, 218 that determines an expectation value 186, 286 based on the output and corresponding to a vibrationally resolved electronic spectrum 190, 290 of a molecule.

A benefit of the system, computer-implemented method and/or computer program product can be an ability to, during quantum experiment setup, perform an easy initialization of an initial state of the qubits being employed in that the quantum circuit executed and/or directed to be executed by the system, computer-implemented method and/or computer program product employs a ground state of zero for each of the qubits being employed.

Another benefit of the system, computer-implemented method and/or computer program product can be an ability to employ a single ancilla qubit and magnitudes fewer gates than conventional frameworks for determining a vibrationally resolved electronic spectrum of a molecule. That is, a number of cycles, a number of qubits employed, a quantum circuit qubit depth, a quantum circuit gate quantity, a quantum circuit gate complexity, a power employed and a time employed to determine such vibrationally resolved electronic spectrum is significantly reduced as compared to conventional frameworks.

Yet another benefit of the system, computer-implemented method and/or computer program product can be a reduction in errors cause and/or assumptions taken to determine the vibrationally resolved electronic spectrum of a molecule, such as in view of lack of use of quantum phase estimation and/or fault tolerancing. In connection therewith, the system, computer-implemented method and/or computer program product can employ a framework that is easily amenable to error mitigation, as compared to conventional frameworks employing QPE for which error mitigation at a level necessary for determination of vibrationally resolved electronic spectra is not presently possible.

Still another benefit of the system, computer-implemented method and/or computer program product can be an ability for use thereof with industries requiring rapid vibrationally resolved electronic spectra determination for manufacture of large quantities of products, such as with respect to vibronic spectra of lithium ions relative to battery manufacturing.

Indeed, in view of the one or more embodiments described herein, a practical application of the one or more systems, computer-implemented methods and/or computer program products described herein can be an increased efficiency of determination of values related to vibrationally resolved electronic spectra by provided for more accurate values, such as the expectation values determined herein, by providing a framework employing reduced errors, reduced assumptions taken, reduced quantum circuit depth and reduced quantity of qubits employed than conventional frameworks.

Accordingly, the applicant has discovered that employing a Hadamard test-based and time dependent quantum algorithm approach to determining vibrationally resolved electronic spectra, as opposed to employing conventional frameworks including quantum phase estimation, can allow for increased accuracy in the resulting determined vibrationally resolved electronic spectra. Furthermore, the use of the one or more frameworks described herein can be employed relative to any molecule for which a vibrationally resolved electronic spectrum is sought, without an increase in the number of ancilla qubits employed from one ancilla qubit and while providing a consistently achievable resolution of the vibrationally resolved electronic spectrum (such as a 50 cm⁻¹ resolution) based on the use of the single ancilla qubit. As a result, use of the one or more embodiments described herein can allow for reduced and/or more efficient use of a quantum computer as compared to existing frameworks, both due to the reduction in ancilla qubits and the easy initialization of qubit initial states.

This result is surprising because it has been traditionally believed that the determination of a vibrationally resolved electronic spectrum, would result in acceptance of known errors, use of accuracy-reducing assumptions, and/or use of impossibly-performable error mitigation due to one or more limitations of current-day quantum computers. See for example graph of a quantity of twirl groups that deviate significantly from one another, overshoot equal distribution, and/or cause inefficient convergence or even overshoot of an expectation value being sought. See, for example, graph 800 at FIG. 8, where the y-axis would be more complexly replaced with “Number of Control/Ancilla Qubits Employed” for use with conventional frameworks (such as employing QPE).

Accordingly, it was unforeseen that employment of a Hadamard test-based time dependent quantum algorithm approach could allow for easy and efficient determination of vibrationally resolved electronic spectra while having a low control qubit quantity of one, regardless of molecule for which a vibrationally resolved electronic spectrum is being determined, and while allow for corresponding easy and efficient use of error mitigation due to the low control qubit quantity and associated low quantum circuit depth.

In connection therewith, the one or more embodiments described herein can provide useful and practical applications of computers, thus providing enhanced (e.g., improved and/or optimized) quantum system setup as compared to existing frameworks for determining vibrationally resolved electronic spectra. Overall, such computerized tools can constitute a concrete and tangible technical improvement in the field of quantum processing.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

One or more embodiments described herein can be, in one or more embodiments, inherently and/or inextricably tied to computer technology and cannot be implemented outside of a computing environment. For example, one or more processes performed by one or more embodiments described herein can more efficiently, and even more feasibly, provide program and/or program instruction execution, such as relative to determination of a vibrationally resolved electronic spectrum for a molecule, as compared to existing systems and/or techniques unable to provide such efficiencies. Systems, computer-implemented methods and/or computer program products providing performance of these processes are of great utility in the fields of quantum computing and molecular vibration spectra analysis and cannot be equally practicably implemented in a sensible way outside of a computing environment.

One or more embodiments described herein can employ hardware and/or software to solve problems that are highly technical, that are not abstract, and that cannot be performed as a set of mental acts by a human. For example, a human, or even thousands of humans, cannot efficiently, accurately and/or effectively automatically or even partially automatically perform quantum circuit execution at a plurality of qubits of a quantum system as the one or more embodiments described herein can provide these processes. Moreover, neither can the human mind nor a human with pen and paper conduct these processes, as conducted by one or more embodiments described herein.

In one or more embodiments, one or more of the processes described herein can be performed by one or more specialized computers (e.g., a specialized processing unit, a specialized classical computer, a specialized quantum computer, a specialized hybrid classical/quantum system and/or another type of specialized computer) to execute defined tasks related to the one or more technologies describe above. One or more embodiments described herein and/or components thereof can be employed to solve new problems that arise through advancements in technologies mentioned above, employment of quantum computing systems, cloud computing systems, computer architecture and/or another technology.

One or more embodiments described herein can be fully operational towards performing one or more other functions (e.g., fully powered on, fully executed and/or another function) while also performing one or more of the one or more operations described herein.

To provide additional summary, a listing of embodiments and features thereof is provided.

A system, comprising: a memory that stores computer executable components; and a processor that executes the computer executable components stored in the memory, wherein the computer executable components comprise: an execution component that directs execution of a time dependent quantum algorithm at a quantum processor of a quantum system, wherein the quantum algorithm comprises propagating a wave packet in time under a determined Hamiltonian, resulting in a measurable output at the quantum system; and an evaluation component that determines an expectation value based on the output and corresponding to a vibrationally resolved electronic spectrum of a molecule.

The system of the preceding paragraph, wherein the time dependent algorithm is configured to simulate a time evolution with the Hamiltonian.

The system of any preceding paragraph, wherein the directing of the execution of the time dependent quantum algorithm by the execution component comprises directing the execution of a quantum circuit corresponding to the time dependent quantum algorithm, wherein the quantum circuit employs a data qubit and an ancilla qubit of the quantum processor of the quantum system.

The system of any preceding paragraph, wherein the directing of the execution of the time dependent quantum algorithm by the execution component comprises directing performance of a Hadamard gate on the ancilla qubit and subsequent performance of a controlled e^{-iHt} gate employing the data qubit and the ancilla qubit.

The system of any preceding paragraph, wherein the directing of the execution of the time dependent quantum algorithm by the execution component further comprises directing a second performance of a Hadamard gate on the ancilla qubit and subsequent measuring of the ancilla qubit in a Z-basis.

The system of any preceding paragraph, further comprising the quantum system comprising an orchestrator component that, prior to the performance of the Hadamard gate on the ancilla qubit, initializes the ancilla qubit and the data qubit at a ground state of the Hamiltonian where the respective ground state of the ancilla qubit is zero and the respective ground state of the data qubit is zero.

The system of any preceding paragraph, wherein the measuring of the ancilla qubit in the Z-basis is the same regardless of a number of data qubits, including the data qubit, to be employed to execute the quantum circuit and regardless of a qubit depth of the quantum circuit.

The system of any preceding paragraph, wherein the computer executable components further comprise: a repetition component that, based on a cycle number corresponding to a quantity of different time factors employed for different quantum algorithms, including the quantum algorithm, directs repetition, a number of times equal to the cycle number, of the processes performed by the execution component and the evaluation component.

A computer-implemented method, comprising: directing, by a system operatively coupled to a processor, execution of a time dependent quantum algorithm at a quantum processor of a quantum system, wherein the quantum algorithm comprises propagating a wave packet in time under a determined Hamiltonian, resulting in a measurable output at the quantum system; and determining, by the system, an expectation value based on the output and corresponding to a vibrationally resolved electronic spectrum of a molecule.

The computer-implemented method of the preceding paragraph, wherein the time dependent algorithm is configured to simulate a time evolution with the Hamiltonian.

The computer-implemented method of any preceding paragraph, wherein the directing of the execution of the time dependent quantum algorithm comprises directing the execution of a quantum circuit corresponding to the time dependent quantum algorithm, wherein the quantum circuit employs a data qubit and an ancilla qubit of the quantum processor of the quantum system.

The computer-implemented method of any preceding paragraph, wherein the directing of the execution of the time dependent quantum algorithm further comprises directing performance of a Hadamard gate on the ancilla qubit and subsequent performance of a controlled e^{-iHt} gate employing the data qubit and the ancilla qubit.

The computer-implemented method of any preceding paragraph, wherein the directing of the execution of the time dependent quantum algorithm further comprises directing a second performance of a Hadamard gate on the ancilla qubit and subsequent measuring of the ancilla qubit in a Z-basis.

The computer-implemented method of any preceding paragraph, further comprising: based on a cycle number corresponding to a quantity of different time factors employed for different quantum algorithms, including the quantum algorithm, directing repetition, by the system, a number of times equal to the cycle number, of execution of the time dependent quantum algorithm at a quantum processor of the quantum system and of the determining of the expectation value.

The computer-implemented method of any preceding paragraph, further comprising: prior to the performance of the Hadamard gate on the ancilla qubit, initializing, by the quantum system, the ancilla qubit and the data qubit at a ground state of the Hamiltonian where the respective ground state of the ancilla qubit is zero and the respective ground state of the data qubit is zero.

The computer-implemented method of any preceding paragraph, wherein the measuring of the ancilla qubit in the Z-basis is the same regardless of the number of qubits to be employed to execute the quantum circuit and regardless of a qubit depth of the quantum circuit.

A computer program product facilitating a process to determine a vibrationally resolved electronic spectrum of a molecule, the computer program product comprising a computer readable storage medium having program instructions embodied therewith, the program instructions executable by a processor to cause the processor to: direct, by the processor, execution of a time dependent quantum algorithm at a quantum processor of a quantum system, wherein the quantum algorithm comprises propagating a wave packet in time under a determined Hamiltonian, resulting in a measurable output at the quantum system; and determine, by the processor, an expectation value based on the output and corresponding to the vibrationally resolved electronic spectrum of the molecule.

The computer program product of the preceding paragraph, wherein the time dependent algorithm is configured to simulate a time evolution with the Hamiltonian.

The computer program product of any preceding paragraph, wherein the program instructions are further executable by the processor to cause the processor to: based on a cycle number corresponding to a number of different time factors employed for different quantum algorithms, including the quantum algorithm, direct repetition, by the processor, a number of times equal to the cycle number, of execution of the time dependent quantum algorithm at a quantum processor of the quantum system and of the determining of the expectation value.

The computer program product of any preceding paragraph, wherein the program instructions are further executable by the processor to cause the processor to: prior to the directing of the execution of the time dependent quantum algorithm at the quantum system, direct, by the processor, initialization at the quantum system of a pair of qubits of the quantum processor, which are mapped as corresponding to an ancilla qubit and a data qubit of a quantum circuit based on the quantum algorithm, at a ground state of the Hamiltonian where the respective ground state of the ancilla qubit is zero and the respective ground state of the data qubit is zero.

### Computing Environment Description

Turning next to FIG. 11, a detailed description is provided of additional context for the one or more embodiments described herein at FIGS. 1-10.

FIG. 11 and the following discussion are intended to provide a brief, general description of a suitable computing environment 1100 in which one or more embodiments described herein at FIGS. 1-10 can be implemented. For example, various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1100 contains an example of an environment for the execution of at least some of the computer code involved in performing the inventive methods, such as translation of an original source code based on a configuration of a VRES evaluation code 1180. In addition to block 1180, computing environment 1100 includes, for example, computer 1101, wide area network (WAN) 1102, end user device (EUD) 1103, remote server 1104, public cloud 1105, and private cloud 1106. In this embodiment, computer 1101 includes processor set 1110 (including processing circuitry 1120 and cache 1121), communication fabric 1111, volatile memory 1112, persistent storage 1113 (including operating system 1122 and block 1180, as identified above), peripheral device set 1114 (including user interface (UI), device set 1123, storage 1124, and Internet of Things (IoT) sensor set 1125), and network module 1115. Remote server 1104 includes remote database 1130. Public cloud 1105 includes gateway 1140, cloud orchestration module 1141, host physical machine set 1142, virtual machine set 1143, and container set 1144.

COMPUTER 1101 may take the form of a desktop computer, laptop computer, tablet computer, smart phone, smart watch or other wearable computer, mainframe computer, quantum system or any other form of computer or mobile device now known or to be developed in the future that is capable of running a program, accessing a network or querying a database, such as remote database 1130. As is well understood in the art of computer technology, and depending upon the technology, performance of a computer-implemented method may be distributed among multiple computers and/or between multiple locations. On the other hand, in this presentation of computing environment 1100, detailed discussion is focused on a single computer, specifically computer 1101, to keep the presentation as simple as possible. Computer 1101 may be located in a cloud, even though it is not shown in a cloud in FIG. 11. On the other hand, computer 1101 is not required to be in a cloud except to any extent as may be affirmatively indicated.

PROCESSOR SET 1110 includes one, or more, computer processors of any type now known or to be developed in the future. Processing circuitry 1120 may be distributed over multiple packages, for example, multiple, coordinated integrated circuit chips. Processing circuitry 1120 may implement multiple processor threads and/or multiple processor cores. Cache 1121 is memory that is located in the processor chip package and is typically used for data or code that should be available for rapid access by the threads or cores running on processor set 1110. Cache memories are typically organized into multiple levels depending upon relative proximity to the processing circuitry. Alternatively, some, or all, of the cache for the processor set may be located “off chip.” In some computing environments, processor set 1110 may be designed for working with qubits and performing quantum computing.

Computer readable program instructions are typically loaded onto computer 1101 to cause a series of operational steps to be performed by processor set 1110 of computer 1101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1121 and the other storage media discussed below. The program instructions, and associated data, are accessed by processor set 1110 to control and direct performance of the inventive methods. In computing environment 1100, one or more instructions for performing the inventive methods may be stored in block 1180 in persistent storage 1113.

COMMUNICATION FABRIC 1111 is the signal conduction path that allows the various components of computer 1101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1112 is any type of volatile memory now known or to be developed in the future. Examples include dynamic type random access memory (RAM) or static type RAM. Typically, the volatile memory is characterized by random access, but this is not required unless affirmatively indicated. In computer 1101, the volatile memory 1112 is located in a single package and is internal to computer 1101, but, alternatively or additionally, the volatile memory may be distributed over multiple packages and/or located externally with respect to computer 1101.

PERSISTENT STORAGE 1113 is any form of non-volatile storage for computers that is now known or to be developed in the future. The non-volatility of this storage means that the stored data is maintained regardless of whether power is being supplied to computer 1101 and/or directly to persistent storage 1113. Persistent storage 1113 may be a read only memory (ROM), but typically at least a portion of the persistent storage allows writing of data, deletion of data and re-writing of data. Some familiar forms of persistent storage include magnetic disks and solid-state storage devices. Operating system 1122 may take several forms, such as various known proprietary operating systems or open-source Portable Operating System Interface type operating systems that employ a kernel. The code included in block 1180 typically includes at least some of the computer code involved in performing the inventive methods.

PERIPHERAL DEVICE SET 1114 includes the set of peripheral devices of computer 1101. Data communication connections between the peripheral devices and the other components of computer 1101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1123 may include components such as a display screen, speaker, microphone, wearable devices (such as goggles and smart watches), keyboard, mouse, printer, touchpad, game controllers, and haptic devices. Storage 1124 is external storage, such as an external hard drive, or insertable storage, such as an SD card. Storage 1124 may be persistent and/or volatile. In some embodiments, storage 1124 may take the form of a quantum computing storage device for storing data in the form of qubits. In embodiments where computer 1101 is required to have a large amount of storage (for example, where computer 1101 locally stores and manages a large database) then this storage may be provided by peripheral storage devices designed for storing large amounts of data, such as a storage area network (SAN) that is shared by multiple, geographically distributed computers. IoT sensor set 1125 is made up of sensors that can be used in Internet of Things applications. For example, one sensor may be a thermometer and another sensor may be a motion detector.

NETWORK MODULE 1115 is the collection of computer software, hardware, and firmware that allows computer 1101 to communicate with other computers through WAN 1102. Network module 1115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1115 are performed on the same physical hardware device. In other embodiments (for example, embodiments that utilize software-defined networking (SDN)), the control functions and the forwarding functions of network module 1115 are performed on physically separate devices, such that the control functions manage several different network hardware devices. Computer readable program instructions for performing the inventive methods can typically be downloaded to computer 1101 from an external computer or external storage device through a network adapter card or network interface included in network module 1115.

WAN 1102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1103 is any computer system that is used and controlled by an end user (for example, a customer of an enterprise that operates computer 1101) and may take any of the forms discussed above in connection with computer 1101. EUD 1103 typically receives helpful and useful data from the operations of computer 1101. For example, in a hypothetical case where computer 1101 is designed to provide a recommendation to an end user, this recommendation would typically be communicated from network module 1115 of computer 1101 through WAN 1102 to EUD 1103. In this way, EUD 1103 can display, or otherwise present, the recommendation to an end user. In some embodiments, EUD 1103 may be a client device, such as thin client, heavy client, mainframe computer, desktop computer and so on.

REMOTE SERVER 1104 is any computer system that serves at least some data and/or functionality to computer 1101. Remote server 1104 may be controlled and used by the same entity that operates computer 1101. Remote server 1104 represents the machine that collects and stores helpful and useful data for use by other computers, such as computer 1101. For example, in a hypothetical case where computer 1101 is designed and programmed to provide a recommendation based on historical data, then this historical data may be provided to computer 1101 from remote database 1130 of remote server 1104.

PUBLIC CLOUD 1105 is any computer system available for use by multiple entities that provides on-demand availability of computer system resources and/or other computer capabilities, especially data storage (cloud storage) and computing power, without direct active management by the scale. The direct and active management of the computing resources of public cloud 1105 is performed by the computer hardware and/or software of cloud orchestration module 1141. The computing resources provided by public cloud 1105 are typically implemented by virtual computing environments that run on various computers making up the computers of host physical machine set 1142, which is the universe of physical computers in and/or available to public cloud 1105. The virtual computing environments (VCEs) typically take the form of virtual machines from virtual machine set 1143 and/or containers from container set 1144. It is understood that these VCEs may be stored as images and may be transferred among and between the various physical machine hosts, either as images or after instantiation of the VCE. Cloud orchestration module 1141 manages the transfer and storage of images, deploys new instantiations of VCEs and manages active instantiations of VCE deployments. Gateway 1140 is the collection of computer software, hardware, and firmware that allows public cloud 1105 to communicate via WAN 1102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1106 is similar to public cloud 1105, except that the computing resources are only available for use by a single enterprise. While private cloud 1106 is depicted as being in communication with WAN 1102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1105 and private cloud 1106 are both part of a larger hybrid cloud.

### ADDITIONAL CLOSING INFORMATION

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer executable components; and
a processor, operably coupled to the memory, that executes the computer executable components stored in the memory, wherein the computer executable components comprise:
an execution component that directs execution of a time dependent quantum algorithm at a quantum processor of a quantum system, wherein the quantum algorithm comprises propagating a wave packet in time under a determined Hamiltonian, resulting in a measurable output at the quantum system; and
an evaluation component that determines an expectation value based on the output and corresponding to a vibrationally resolved electronic spectrum of a molecule.

2. The system of claim 1, wherein the time dependent algorithm is configured to simulate a time evolution with the Hamiltonian.

3. The system of claim 1, wherein the directing of the execution of the time dependent quantum algorithm by the execution component comprises directing the execution of a quantum circuit corresponding to the time dependent quantum algorithm, wherein the quantum circuit employs a data qubit and an ancilla qubit of the quantum processor of the quantum system.

4. The system of claim 3, wherein the directing of the execution of the time dependent quantum algorithm by the execution component comprises directing performance of a Hadamard gate on the ancilla qubit and subsequent performance of a controlled e^{-iHt} gate employing the data qubit and the ancilla qubit.

5. The system of claim 4, wherein the directing of the execution of the time dependent quantum algorithm by the execution component further comprises directing a second performance of a Hadamard gate on the ancilla qubit and subsequent measuring of the ancilla qubit in a Z-basis.

6. The system of claim 4, further comprising the quantum system comprising an orchestrator component that, prior to the performance of the Hadamard gate on the ancilla qubit, initializes the ancilla qubit and the data qubit at a ground state of the Hamiltonian where the respective ground state of the ancilla qubit is zero and the respective ground state of the data qubit is zero.

7. The system of claim 5, wherein the measuring of the ancilla qubit in the Z-basis is the same regardless of a number of data qubits, including the data qubit, to be employed to execute the quantum circuit and regardless of a qubit depth of the quantum circuit.

8. The system of claim 1, wherein the computer executable components further comprise:
a repetition component that, based on a cycle number corresponding to a quantity of different time factors employed for different quantum algorithms, including the quantum algorithm, directs repetition, a number of times equal to the cycle number, of the processes performed by the execution component and the evaluation component.

9. A computer-implemented method, comprising:
directing, by a system operatively coupled to a processor, execution of a time dependent quantum algorithm at a quantum processor of a quantum system, wherein the quantum algorithm comprises propagating a wave packet in time under a determined Hamiltonian, resulting in a measurable output at the quantum system; and
determining, by the system, an expectation value based on the output and corresponding to a vibrationally resolved electronic spectrum of a molecule.

10. The computer-implemented method of claim 9, wherein the time dependent algorithm is configured to simulate a time evolution with the Hamiltonian.

11. The computer-implemented method of claim 9, wherein the directing of the execution of the time dependent quantum algorithm comprises directing the execution of a quantum circuit corresponding to the time dependent quantum algorithm, wherein the quantum circuit employs a data qubit and an ancilla qubit of the quantum processor of the quantum system.

12. The computer-implemented method of claim 11, wherein the directing of the execution of the time dependent quantum algorithm further comprises directing performance of a Hadamard gate on the ancilla qubit and subsequent performance of a controlled e^{-iHt} gate employing the data qubit and the ancilla qubit.

13. The computer-implemented method of claim 12, wherein the directing of the execution of the time dependent quantum algorithm further comprises directing a second performance of a Hadamard gate on the ancilla qubit and subsequent measuring of the ancilla qubit in a Z-basis.

14. The computer-implemented method of claim 9, further comprising:
based on a cycle number corresponding to a quantity of different time factors employed for different quantum algorithms, including the quantum algorithm, directing repetition, by the system, a number of times equal to the cycle number, of execution of the time dependent quantum algorithm at a quantum processor of the quantum system and of the determining of the expectation value.

15. The computer-implemented method of claim 12, further comprising:
prior to the performance of the Hadamard gate on the ancilla qubit, initializing, by the quantum system, the ancilla qubit and the data qubit at a ground state of the Hamiltonian where the respective ground state of the ancilla qubit is zero and the respective ground state of the data qubit is zero.

16. The computer-implemented method of claim 13, wherein the measuring of the ancilla qubit in the Z-basis is the same regardless of the number of qubits to be employed to execute the quantum circuit and regardless of a qubit depth of the quantum circuit.

17. A computer program product facilitating a process to determine a vibrationally resolved electronic spectrum of a molecule, the computer program product comprising a computer readable storage medium having program instructions embodied therewith, the program instructions executable by a processor to cause the processor to:
direct, by the processor, execution of a time dependent quantum algorithm at a quantum processor of a quantum system, wherein the quantum algorithm comprises propagating a wave packet in time under a determined Hamiltonian, resulting in a measurable output at the quantum system; and
determine, by the processor, an expectation value based on the output and corresponding to the vibrationally resolved electronic spectrum of the molecule.

18. The computer program product of claim 17, wherein the time dependent algorithm is configured to simulate a time evolution with the Hamiltonian.

19. The computer program product of claim 17, wherein the program instructions are further executable by the processor to cause the processor to:
based on a cycle number corresponding to a number of different time factors employed for different quantum algorithms, including the quantum algorithm, direct repetition, by the processor, a number of times equal to the cycle number, of execution of the time dependent quantum algorithm at a quantum processor of the quantum system and of the determining of the expectation value.

20. The computer program product of claim 17, wherein the program instructions are further executable by the processor to cause the processor to:
prior to the directing of the execution of the time dependent quantum algorithm at the quantum system, direct, by the processor, initialization at the quantum system of a pair of qubits of the quantum processor, which are mapped as corresponding to an ancilla qubit and a data qubit of a quantum circuit based on the quantum algorithm, at a ground state of the Hamiltonian where the respective ground state of the ancilla qubit is zero and the respective ground state of the data qubit is zero.
